(19) United States
(12) Patent Application Publication
(10) Pub. No.: US 2009/0177539 A1
(43) Pub. Date: Jul. 9, 2009

(54) METHOD AND APPARATUS FOR DUAL SYSTEM DETECTION

(75) Inventor: Chad Pham, Glendale, CA (US)

Correspondence Address: FITZPATRICK CELLA HARPER & SCINTO, 30 ROCKEFELLER PLAZA, NEW YORK, NY, 10112, US

(73) Assignee: FUTURELOGIC, INC., Glendale, CA (US)

(21) Appl. No.: 12/094,146

(22) PCT Filed: Nov. 16, 2006
(86) PCT No.: PCT/US06/44510

§ 371 Date: Nov. 7, 2008

Related U.S. Application Data
(60) Provisional application No. 60/737,516, filed on Nov. 16, 2005.

(51) Int. Cl. G06Q 30/00; G06Q 50/00; G06F 3/12

(52) U.S. Cl. 705/14; 358/1.15

(57) ABSTRACT

A printer capable of detecting whether the printer is operating within a gaming system to perform gaming voucher printing, or within a promotional system to perform promotional coupon printing, or within both systems. The printer performs the operations of the identified system by providing one firmware that can detect whether the printer is operating within a gaming system to perform gaming voucher printing, or within a promotional system to perform promotional coupon printing, or within both systems.

### CROSS-REFERENCE TO RELATED APPLICATIONS

The present application claims the benefit us U.S. Provisional Application No. 60/737,516 filed Nov. 16, 2005, the contents of which are incorporated by reference as if stated in full herein.

### BACKGROUND OF THE INVENTION

1. Field of the Invention

This invention relates generally to printers and printer connected hardware used in cashless enabled games and gaming tables, and more specifically to hardware and firmware operating within this equipment by providing firmware which can detect whether the printer is operating within a gaming system to perform gaming voucher printing, within a promotional system to perform promotional coupon printing, or within both systems.

2. Background

The gaming machine manufacturing industry provides a variety of gaming machines for the amusement of gambling players. An exemplary gaming machine is a slot machine. A slot machine is an electromechanical game wherein chance or the skill of a player determines the outcome of the game. Slot machines are usually found in casinos or other more informal gaming establishments.

The gaming machine manufacturers have more recently introduced cashless enabled games to the market and these have begun to find wide acceptance in that industry. Cashless enabled games are so named due to the fact that they can conduct their player's financial exchange with a mixture of traditional currency and vouchers. Typically, a cashless enabled game has as installed components a printer to produce the vouchers, and a bill acceptor that supports automatic reading of the vouchers. In a cashless enabled gaming system, when a player cashes out, the system is signaled and depending on the size of the payout, the system can either present coins in the traditional method of a gaming machine, or it can cause the printers which are installed in such machines to produce a voucher containing the value of the payout. The voucher may then either be redeemed for cash at a cashier's cage, redemption kiosk, or inserted into a bill acceptor which is installed in the same or another cashless enabled gaming machine at a participating casino, at which point the system will recognize the voucher, redeem it and place the appropriate amount of playing credits on the game.

Over the last several years, cashless enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. This increasing acceptance practically guarantees a wide installed base of networked games with captive player audiences for couponing and promotional coupons using generally the same equipment already installed within the game for the purpose of supporting cashless gaming vouchers.

The printer contained in the gaming machine includes electrical, mechanical and electronic hardware and a computer program that is included in a memory device such as a flash memory chip, or other programmable storage devices. This computer program is commonly referred to as firmware. The firmware controls the operation of the printer.

Practical field experience with the application has illustrated that there are areas needing improvement in the current printer designs and implementation within the game. One such needed improvement is to provide firmware which can detect whether the printer is in a gaming system or promotional system or combination thereof. Various aspects of the invention meet such a need.

### DEFINITIONS

For the purposes of this document the following definitions apply:
“Gaming establishment”—a gaming entity such as a casino.
“Gaming system”—a host system used in a gaming establishment which controls a plurality of games, such as cashless enabled slot machines, to perform gaming voucher printing.
“Promotional system”—a host system used in a gaming establishment which controls and performs the printing of promotional coupons and other printed items of interest to a gaming establishment or its patrons.

### SUMMARY OF THE INVENTION

In one aspect of the invention, a printer comprises a processor, printer memory, firmware, printing algorithms, a storage device, and a printer controller, the printer prints gaming vouchers, promotional coupons and other printed items of interest to a gaming establishment or its patrons.

In another aspect of the invention, a printer is coupled to a computer program, such as firmware, the firmware residing in a printer memory. A mathematical formula is applied to the contents of the printer memory, often called the binary image of the firmware, the formula generating a number that represents the contents of the printer memory in a statistically unique way. The number is used as a signature for the binary image of the firmware or data included in the sectioned memory.

In another aspect of the invention, a printer is coupled to a cashless enabled game or gaming table in a gaming system to perform gaming voucher printing.

In another aspect of the invention, a printer is coupled to a promotional system to perform promotional coupon printing.

In another aspect of the invention, a printer is coupled to a cashless enabled game or gaming table in a gaming system to perform gaming voucher printer and a promotional system to perform promotional coupon printing.

In another aspect of the invention, the printer memory may comprise multiple sections, each section dedicated to certain aspects of the printer, such as printer operation, system detection, voucher information, and coupon information.

In another aspect of the invention, the printer memory comprises a section for system detection, the system detection section detects the system to which the printer is connected.

In another aspect of the invention, the printer memory comprises a section for printer operation, the printer operation section including printer operation programming instructions and data.

In another aspect of the invention, the printer memory comprises a section for voucher information, the voucher information section including voucher generation instructions and data.

In another aspect of the invention, the printer memory comprises a section for coupon information, the coupon information section including promotional coupon generation instructions and data.

In another aspect of the invention, the firmware enables the printer to configure itself to perform gaming voucher printing, promotional coupon printing, or a combination thereof.

In another aspect of the invention, the firmware of a printer enables the printer to detect whether the printer is operating in a cashless enabled game or gaming table within a gaming system to perform gaming voucher printing, a promotional system to perform promotional coupon printing, or a combination thereof without cycling the power to the printer.

In another aspect of the invention, the firmware of a printer enables the printer to perform a pre-calibration if the existence of a gaming system is detected, the pre-calibration eliminating any paper misalignment or paper jams in the printer whereby a voucher is printed by the printer, moved through the paper path of the printer, and separated from the paper supply.

In another aspect of the invention, the firmware of a printer enables the printer to perform a coupon holding process if the existence of a promotional system is detected, the coupon holding process preventing individual promotional coupons from being separated from the paper supply if multiple promotional coupons are being printed; detecting when the last promotional coupon was printed; and preventing the pre-calibration of the printer to speed up the promotional coupon printing process.

In another aspect of the invention, the firmware may be used to detect the existence of both a gaming system and promotional system upon the establishment of communication between the printer and one or more host systems.

In another aspect of the invention, processes are used by a gaming system, a promotional system, or combination thereof to establish communication with the printer during power up of the printer, the processes detecting a printer, checking the status of a printer, or notifying the printer of the type of host system or plurality of host systems to which the printer is connected, among others.

In another aspect of the invention, processes are used to establish communication between a printer and a gaming system, a promotional system, or combination thereof without recycling the power to the printer, the processes detecting a printer, checking the status of a printer, or notifying the printer of the type of host system or plurality of host systems to which the printer is connected, among others.

### BRIEF DESCRIPTION OF THE DRAWINGS

These and other features, aspects, and advantages of the invention will become better understood with regard to the following description and accompanying drawings where:

FIG. 1 is a cashless enabled gaming system in accordance with an exemplary embodiment of the invention.

FIG. 2 is a promotional system in accordance with an exemplary embodiment of the invention.

FIG. 3 is a block diagram of a printer controller used to control a printer in a gaming system, promotional system, or combination thereof in accordance with an exemplary embodiment of the invention.

FIG. 4 is a diagram of a system connection check process used by the printer in a gaming system, promotional system, or combination thereof in accordance with an exemplary embodiment of the invention.

FIG. 5 is a diagram of dual system processing in accordance with an exemplary embodiment of the invention.

FIG. 6 is a diagram of the processes used in a gaming system in accordance with an exemplary embodiment of the invention.

FIG. 7 is a diagram of the processes used in a promotional system in accordance with an exemplary embodiment of the invention.

### DETAILED DESCRIPTION

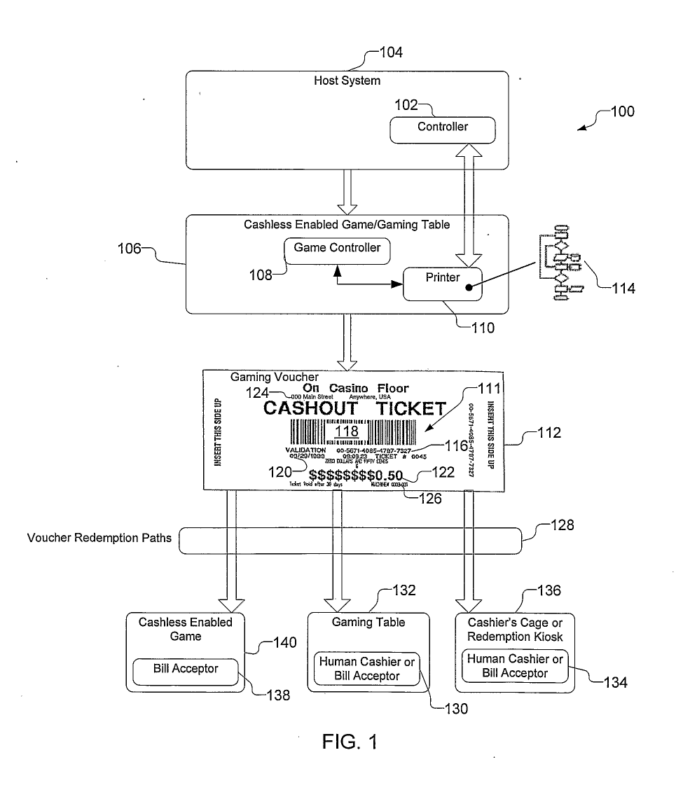

FIG. 1 is a cashless enabled gaming system in accordance with an exemplary embodiment of the invention. As illustrated, a cashless enabled gaming system 100 includes a system controller 102 hosted by a host system 104 coupled to one or a plurality of cashless enabled games 106 or gaming tables. A cashless enabled game or gaming table includes a game controller 108 that controls the operation of that game or gaming table. The game controller is coupled to a printer 110. The cashless enabled game or gaming table uses the printer to generate value bearing indicia 111 on gaming vouchers such as that illustrated on gaming voucher 112. The printer includes computer-implemented encoded algorithms 114 used in conjunction with stock onto which the value bearing indicia are printed.

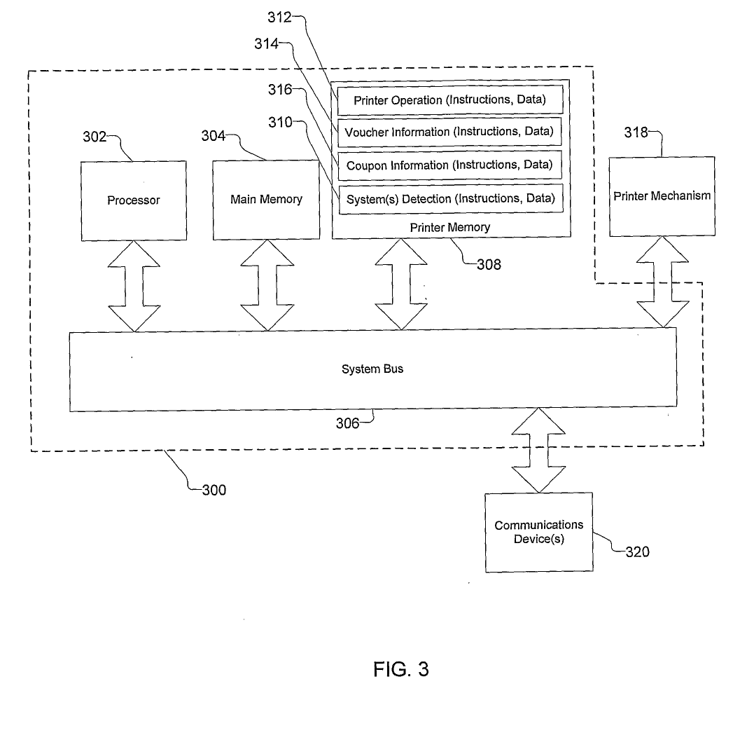

The host system may transmit gaming voucher data or a reference to a gaming voucher as later described in FIG. 3 to the printer, which the printer may store for future use. The gaming voucher 112 includes the cash-out information such as validation number, printed in both a human readable form such as a character string 116 and in machine readable form, such as a barcode 118, time and date stamps 120, cash-out amount 122, casino location information 124, and cashless enabled game identifier 126, among others.

In addition, data that is used to track the usage of gaming vouchers may be included on the gaming voucher. For example, a barcode field or a text field may be used to print a barcode value or text string uniquely identifying the gaming voucher. In this way, a printer creates an image of a barcode or barcodes, characters or marks that may be read by the bill acceptor of the same cashless enabled game or gaming table or another cashless enabled game or gaming table, allowing automatic acceptance of gaming vouchers into a gaming system in the gaming establishment or another related property.

The printer may also be directly coupled to the host system and system controller. This allows the printer to communicate to both the game controller or the host system either sequentially or simultaneously.

The gaming voucher may be redeemed in a variety of ways as illustrated by voucher redemption paths 128. The gaming voucher may be redeemed by a human cashier or bill acceptor 130 at a gaming table 132, by a human cashier or bill acceptor 134 at a cashier's cage or redemption kiosk 136, or by a bill acceptor 138 at another cashless enabled game 140. Redemption is possible after the gaming voucher passes a verification of account information and validation using security signatures included with the gaming voucher.

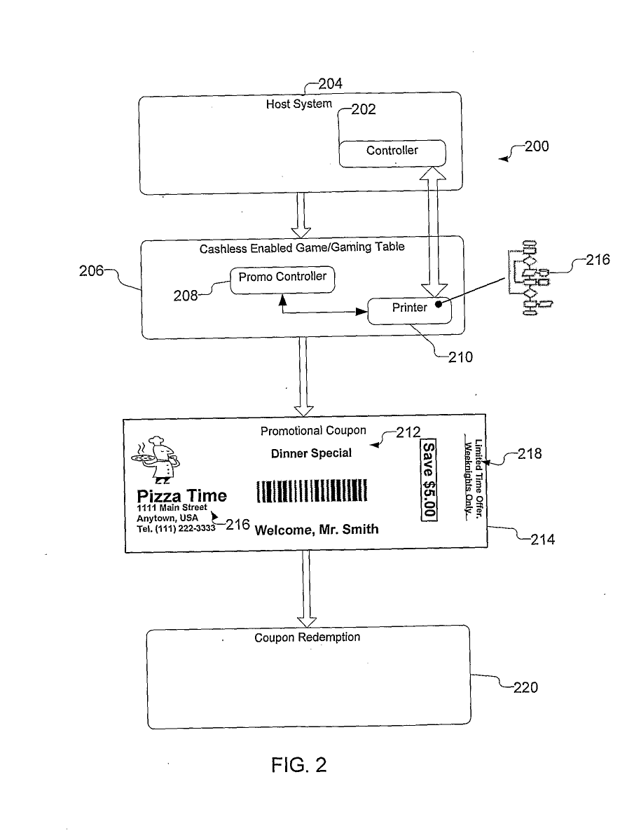

FIG. 2 is a promotional system in accordance with an exemplary embodiment of the invention. As illustrated, a promotional system 200 includes a system controller 202 hosted by a host system 204 coupled to one or a plurality of cashless enabled games or gaming tables 206. A cashless enabled game or gaming table includes a game controller that may also operate as a promotional controller 208 that controls the operation of that game or gaming table. The game controller is coupled to a printer 210. The cashless enabled game or gaming table uses the printer to generate value bearing indicia 212 on promotional coupons such as that illustrated on promotional coupon 214. The printer includes print processes 216 in conjunction with stock onto which the value bearing indicia are printed.

The host system may transmit promotional coupon data or a reference to a promotional coupon to the printer, which the printer may store for future use. A promotional coupon includes the necessary information for a player to redeem the promotional coupon, for example, a redemption location 216 or an expiration date 218 as well as data which may describe the origins of the promotional coupon such as gaming establishment location information.

In addition, data that is used to track the usage of promotional coupons may be included on the promotional coupon. For example, a barcode field or a text field may be used to print a barcode value or text string uniquely identifying the promotional coupon. In this way, a printer creates an image of a barcode or barcodes, characters or marks that may be read by the bill acceptor of the same cashless enabled game or gaming table, another cashless enabled game or gaming table, or mechanism coupled to a bill acceptor such as that which may be in a point-of-sale system, thereby allowing automatic acceptance or redemption 220 of promotional coupons into a promotional system. The printer may also be directly coupled to the host system and system controller.

Referring now to both FIG. 2 and FIG. 1, a gaming establishment may deploy both host system 104 for management of gaming vouchers and host system 204 for management of promotional coupons. In this type of deployment, printers 110 and 210 may be connected to both host system 104 and host system 204. In this arrangement, the printers 110 and 210 will detect which hosts they are connected to and perform processing on the basis of which host or hosts the printers are connected to.

FIG. 3 is a block diagram of a printer controller used to control a printer in a gaming system, promotional system, or combination thereof in accordance with an exemplary embodiment of the invention. As illustrated, a printer controller 300 includes a processor 302 coupled to a main memory 304 by a system bus 306. The printer controller also includes a printer memory 308 coupled to the processor by the system bus, the printer memory including a plurality of memory sections for storing firmware for system detection 310, printer operation 312, voucher information 314, and coupon information 316.

The printer memory, either internal and/or external, may consist of such common devices as RAM, EPROM, EEPROM, FLASH Chips, magnetic storage devices such as floppy or hard drivers, Flash Sticks and other storage media commonly used in the computer industry. The printer memory includes the plurality of memory sections that may be independently addressed for both content read and content write operations. The printer operation section 312 is included for storage of programming instruction codes and printer data used by the processor 302 to operate the printer. The execution of these codes determines the conditions under which voucher information, including voucher generation instructions and voucher data included in the voucher information section 314 are utilized to generate a gaming voucher using a printer mechanism 318. The coupon information section 316 included in the printer memory holds coupon generation instructions and coupon data used by the printer to generate a promotional coupon using the printer mechanism 318.

The system detection section 310 of the printer memory may be used by the printer to configure itself after power up to perform gaming voucher printing, promotional coupon printing, or a combination thereof based on the system or plurality of systems detected. The system detection section may also detect whether the printer is operating in a cashless enabled game or gaming table within a gaming system, a promotional system, or a combination thereof without recycling the power to the printer. Upon detection of a gaming system, the system detection section of the printer memory may then interact with the printer operation section 312 and voucher information section 314 of the printer memory to allow the printer to generate gaming vouchers. Upon detection of a promotional system, the system detection section 310 of the printer memory may then interact with the printer operation section 312 and coupon information section 316 of the printer memory to allow the printer to generate promotional coupons. Upon detection of dual systems of both gaming and promotional systems, the system detection section of the printer memory may then interact with the printer operation section, the voucher information section, and the coupon information section of the printer memory to allow the printer to function with a cashless enabled game or gaming table to generate gaming vouchers and, if necessary or available, promotional coupons.

Generally, the contents of the printer operation section 312 are not changed frequently. The contents of the voucher information section 314 describe the format of the information that is printed on a gaming voucher. Contents of the voucher information section are changed rarely. The coupon information section 316 includes the data that describes the format of the information that is printed on a promotional coupon. The contents of the coupon information section are changed frequently. The contents of system detection section 310 are changed rarely.

The printer controller is also coupled via the system bus to the printer mechanism 318 used to generate gaming vouchers or promotional coupons in accordance with the voucher data and the coupon data stored in the printer memory. One or a plurality of communication devices 320 may be coupled to the system bus for use by the printer controller to communicate with a cashless gaming system host or a game controller and or a promotional system host or promotional controller. The printer controller uses the communication devices to receive commands, program instructions, voucher data, and coupon data from external devices, such as the host systems 104 and 204 of FIGS. 1 and 2, respectively. In addition, the printer controller may use the communication devices to transmit printer status information to the external devices. Other communication devices may also be used by the printer controller to couple in a secure fashion over a local area network for administrative or other purposes.

Additional communication devices and channels may be provided for communication with other peripheral devices as needed. For example, one communication device may be provided with a local communications port, accessible from an exterior of a gaming machine that a technician may use to communicate with the printer controller using an infrared link, other short-range wireless communication link, or a hard link with an external connector in a secure manner.

In operation, the processor loads the programming instruction codes included in the printer operation section 312 into the main memory 304 and executes the programming instruction codes to implement the features of the printer as described herein.

The partitioning of the memory into separate code and data sections enables separate signatures to be maintained for each section. A signature, such as a result of a mathematical formula applied to the contents of the memory section, may be generated for the memory content of a first section, such as the printer operation content, independently of all other memory sections. A second signature may also be generated for a second memory section, such as the voucher data section, independently of all other memory sections. A third signature, may be generated on a third memory section, such as the coupon section, independently of all other memory sections. The signatures provide an identifier that is statistically unique in describing the contents of each memory section. A fourth signature, again as an example of a mathematical formula, may be generated on a fourth memory section, such as the systems detection section, independently of all other memory sections. In addition, a signature may be generated for all the memory sections combined.

In practical use, the sectioned printer memory enables the contents of the second section and/or third section to be viewed and/or updated individually and separately from the contents of the first section. The mathematical formula used to generate the statistically unique identifier or signature of the printer memory may be used to confirm that the printer memory has not changed, through alteration of the programming instruction codes or by other means.

The second section and third section may contain the content of the printed image of a gaming voucher and a promotional coupon, respectively. For example, in the case of a promotional coupon, a gaming establishment operator may want to change the image and contents of the promotional coupon frequently. In this case, the gaming establishment may then change just the third section of memory including the coupon data without disturbing the first section of memory. The conditions that cause the gaming voucher and/or promotional coupon to be printed are controlled by the cashless enabled game or gaming table in accordance with the programming instruction codes and the coupon data.

Another example of a signature is a Cyclic Redundancy Check (“CRC”). For a CRC, a value is derived from, and stored or transmitted with, the block of data to detect corruption. By recalculating the value and comparing it to the value originally transmitted, the receiver can detect some types of data corruptions. A CRC value is calculated using division either using shifts and exclusive Ors or table lookup (modulo 256 or 65536). The CRC value is “redundant” in that it adds no information. A single corrupted bit in the data will result in a one bit change in the calculated CRC values but multiple corrupted bits may cancel each other out. CRCs treat blocks of input bits as coefficient-sets for polynomials. A polynomial representing the data block is a “message polynomial”. A second polynomial, with constant coefficients, is called the “generator polynomial”. The generator polynomial is divided into the message polynomial, giving a quotient and remainder. The coefficients of the remainder from the bits of the final CRC value. So, an order-33 generator polynomial is necessary to generate a 32-bit CRC. The exact bit-set used for the generator polynomial will naturally affect the CRC that is computed.

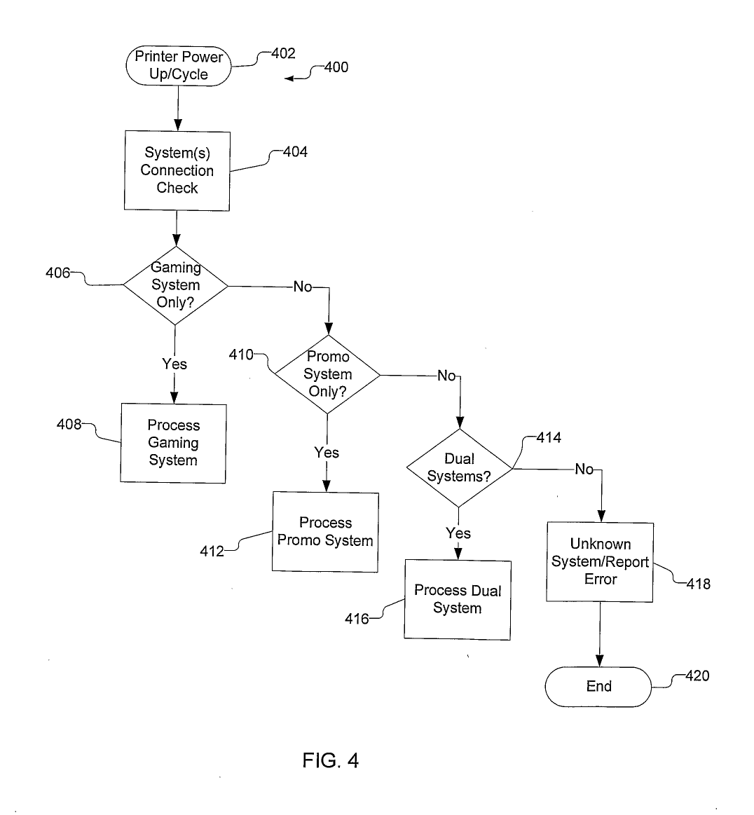

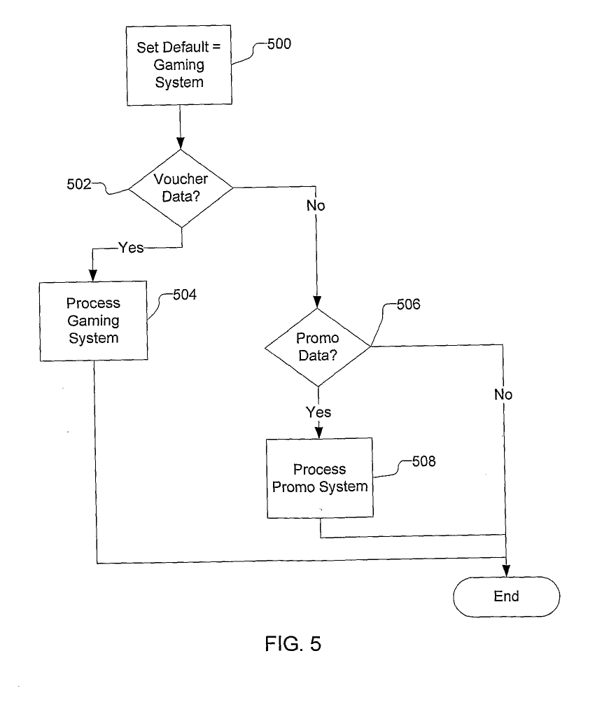

In accordance with an exemplary embodiment, during power up, the processor reads each section of the printer memory to perform a CRC. The results of the CRC are checked against the default CRC previously performed on the printer memory. If the results do not match, an error is generated which may be returned to a host system as previously described in FIG. 1 and FIG. 2 or a dual system as described in FIG. 4 and FIG. 5 and the printer will enter non-operational mode for security purposes.

Referring again to FIG. 1 and the exemplary gaming voucher 112 used in cashless enabled game(s) or gaming table(s) 106, the conditions necessary for printing a gaming voucher are controlled by the game or gaming table 106 and the conditions are communicated to and acted on by the computer code contained in the printer operation section 312 (of FIG. 3) of the printer memory 308 (of FIG. 3). In the exemplary system, the cashless enabled game or gaming table 106 sends the amount of the gaming voucher, the validation number 116 and other controlled information necessary to create a gaming voucher that is redeemable either for play or for currency.

The data contained in the voucher information section of the printer memory 316 (of FIG. 3) relates only to the format of the gaming voucher, such as the locations and size of the individual fields of the gaming voucher. This includes allowable static data such as name and location of the gaming establishment.

Referring again to FIG. 2 and the exemplary promotional coupon 214, the conditions necessary for printing a promotional coupon are controlled by the cashless enabled game or gaming table 206 and the conditions are communicated to and acted on by the computer code contained in the printer operation section 312 (of FIG. 3) of the printer memory 308 (of FIG. 3). The cashless enabled game or gaming table 206 sends the value or type of the promotional coupon 214, a validation number and other controlled information necessary to create a promotional coupon, usually discounts on meals and the like. The data contained in the coupon information section 316 (of FIG. 3) of the printer memory relates only to the format of the promotional coupon, such as the locations and size of the individual fields of the promotional coupons. Because of the promotional nature of this coupon, gaming establishments desire to change the content of these coupons on a regular basis.

Referring again to FIG. 3, the fields of a gaming voucher or promotional coupon are described using description data included in an electronic template that may be stored by a printer in the printer memory 308. These fields may include a barcode field, text field, a graphic field, and line/box draw field. A template may include a plurality of these fields in combination, resulting in a paste-up style printed gaming voucher or promotional coupon. A plurality of templates describing different types of gaming vouchers may be stored in the voucher information section 314 of the printer memory 308 to be used by the printer to support the gaming operations of a gaming establishment. Similarly, a plurality of templates describing different types of promotional coupons may be stored in the coupon information section 316 of the printer memory 308 to be used by the printer to support the promotional operations of a gaming establishment.

The actual value or data for each of the fields described in a template may or may not be included in the template itself. Instead, the template may include instructions on how to generate a gaming voucher or promotional coupon but may not include the actual data printed onto the gaming voucher or promotional coupon. For example, a template may include a barcode field for printing a barcode. However, the actual value of the barcode is transmitted to a printer from a host system at the time a gaming voucher or promotional coupon is generated using the template. In this way, a gaming voucher or promotional coupon may have fields that include static data, such as a logo in a graphic field, or dynamic data, such as the name of a patron in a text field. In this way, customized gaming vouchers or promotional coupons may be printed by a printer without transferring large amounts of data through a communications device.

A template may include a plurality of command strings. Each command string may conform to the following example syntax:
delimiter<cmd_Ltr>|<data_field1>| . . . |<data_fieldx>|delimiter;comment

where:
delimiter=a delimiter character
<cmd_Ltr>=command identifier letter
   |=pipe character. This serves as the delimiter between data fields in a command.
<data_field1−x>fields which include information relative to the command.
; semi-colon. This is a comment field designator.
comment=any comments.

A template adheres to the following syntax:

delimiter<template_cmd_Ltr>|<t_id>|<targ_mem>|<t_dim_da>|<t_dim_pa>|
<pr#1>|<pr#2>|...|<pr#n>|delimiter

where
<t_id>=the template I.D.
<targ_mem>target memory storage.
<t_dim_da>=template dimension on a dotline axis in dots.
<t_dim_pa>=template dimension in dots in the paper axis.
<pr#1>. . . <pr#n>=list of gaming vouchers or promotional coupon data resident print regions IDs used in the format of the gaming voucher or promotional coupon. These fields are the method by which print regions used on a gaming voucher or promotional coupon are linked together and to the template.

A print region is a print field used in a template to format print data. The print region command is used to define the basic types of print regions such as text, barcode, graphics, and line/box draw.

A define print region command defines the particular font, barcode, graphic, or line style which is to be used, and provides special formatting information on how it is to be used. Multiple print regions may be defined and memorized in a printer's sectioned memory.

Referring now to FIG. 1 and FIG. 2, the host systems 104 and 204 may transmit gaming voucher data or promotional coupon data to the printers 110 and 210 to generate the gaming voucher 112 or the promotional coupon 214, respectively. Furthermore, the host systems may also include a reference to a template definition so that the dynamic data transmitted by the host systems can be combined with the static data stored in the printers to generate a complete gaming voucher or promotional coupon depending on the host system. Additionally, since it is possible to store all the fields used on a gaming voucher or promotional coupon with printer memory, the host systems may issue a complete gaming voucher or promotional coupon by simply sending a reference to a gaming voucher or promotional coupon stored in the printer memory to generate the gaming voucher or promotional coupon in its entirety.

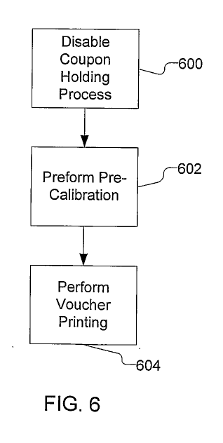

FIG. 4 is a diagram of a system connection check process used by the printer in a gaming system, promotional system, or combination thereof in accordance with an exemplary embodiment of the invention. As illustrated, the process 400 begins with the printer power up (402), after which a system connection check (404) is performed to establish communication with a host system. During the system connection check, the printer may detect (406) that it is connected only to a gaming system, whereby the process continues with processing (408) the gaming system as later described in FIG. 6. Detection may be achieved by determining that a communication port or interface dedicated to connection to a game controller is indeed, connected to an active game controller. Another detection method may include requesting a controller ID from a controller connected to a port or interface and then analyzing a received controller ID. Another method of detection includes analyzing messages received from a connected controller and determining if the messages are for printing gaming machine vouchers or for printing promotional coupons.

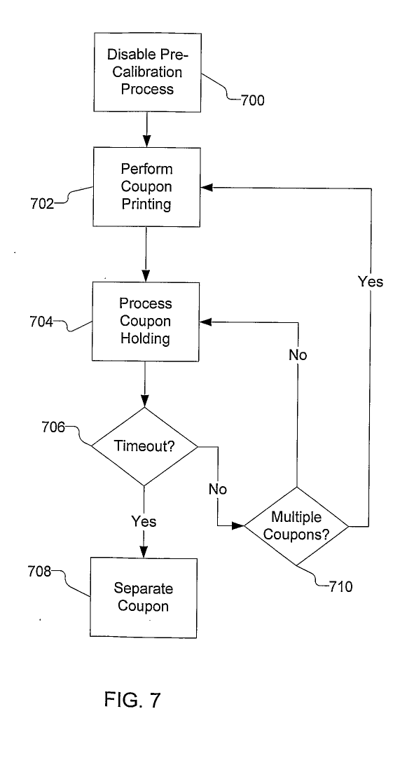

Also during the system connection check, the printer may detect (410) that the printer is connected only to a promotional system, whereby the process continues with processing (412) the promotional system as later described in FIG. 7. Detection may be achieved by determining that a communication port or interface dedicated to connection to a promotional system is indeed, connected to an active promotional system. Another detection method may include requesting a host system ID from a system connected to a port or interface and then analyzing a received host system ID. Another method of detection includes analyzing messages received from a connected host system and determining if the messages are for printing gaming machine vouchers or for printing promotional coupons.

Also during the system connection check, the printer may detect (414) that it is connected to both a gaming and promotional system, whereby the process continues with processing (416) the dual system as later described in FIG. 5. However, if during the system connection check, the printer cannot detect a connection, an error report 418 of an unknown system may be returned to a host system. Then the process ends (420).

Alternatively or in conjunction with detecting connected host systems during a power up or power cycle, the printer may poll for host systems at any time or periodically during the operation of the printer.

FIG. 5 is a diagram of dual system processing in accordance with an exemplary embodiment of the invention. During a system connection check process as previously described in FIG. 4, the printer may detect that it is connected to both a gaming and promotional system. As illustrated in FIG. 5, the process continues with setting (500) the default system to be the gaming system, after which if voucher data is received (502), the process continues with processing (504) the gaming system as later described in FIG. 6. However, if promotional data is received (506) by the printer, the process continues with processing (508) the promotional system as later described in FIG. 7. If neither type of date is received, or the process is finished processing, the process ends (510).

FIG. 6 is a diagram of the processes used in a gaming system in accordance with an exemplary embodiment of the invention. After a connection to a gaming system is established as previously described in FIG. 4, the printer disables (600) a coupon holding process described later in FIG. 7. The printer then processes (602) the algorithms necessary to pre-calibrate the printer to generate gaming vouchers. The pre-calibration process may include programming instructions that cause the printer to pull stock from the paper supply to align the stock in the printer, thereby reducing or eliminating any potential paper jams. Thereafter, when a cash-out signal is received from a cashless enabled game or gaming table within a gaming system, the printer will perform (604) voucher printing.

FIG. 7 is a diagram of the processes used in a promotional system in accordance with an exemplary embodiment of the invention. After a connection to a promotional system is established as previously described in FIG. 4, the printer disables (700) the pre-calibration process previously described in FIG. 6. When a signal for promotional coupon generation is received from a cashless enabled game or gaming table within a promotional system, the printer will perform coupon printing (702).

After printing a promotional coupon, the printer processes coupon holding (704). The coupon holding process may be used to set up (706) a timeout to prevent the separation of a promotional coupon from the paper supply thereby speeding up the process of printing multiple promotional coupons. The timeout may be set to one or more seconds in duration.

During the coupon holding process, the printer may use timer algorithms to set a specific time for holding the promotional coupons before coupon separation. If the timeout event occurs before the next promotional coupon data is received, the coupon separation process (708) will take place; otherwise, the process will return to performing multiple coupon printing (710).

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of printer operation, comprising:
detecting by the printer if the printer is coupled to a cashless enabled game within a gaming system;
detecting by the printer if the printer is coupled to a promotional system;
performing by the printer gaming voucher printing when the printer detects the printer is coupled to the cashless enabled game;
performing by the printer promotional coupon printing when the printer detects the printer is coupled to the promotional system; and
performing by the printer both gaming voucher printing and promotional coupon printing when the printer detects the printer is coupled to both the cashless enabled game and the promotional system.

2. The method of claim 1, further comprising performing the detecting by the printer if the printer is coupled to the cashless enabled game within a gaming system and the detecting by the printer if the printer is coupled to the promotional system when power is cycled to the printer.

3. The method of claim 1, further comprising performing the detecting by the printer if the printer is coupled to the cashless enabled game within a gaming system and performing the detecting by the printer if the printer is coupled to the promotional system on a periodic basis.

4. The method of claim 1, further comprising performing by the printer a pre-calibration when the printer detects the printer is coupled to the cashless enabled game.

5. The method of claim 1, further comprising performing by the printer a coupon holding process when the printer detects the printer is coupled to the promotional system, the coupon holding process preventing individual promotional coupons from being separated from a paper supply if multiple promotional coupons are being printed.

6. The method of claim 5, further comprising:
detecting by the printer when the last promotional coupon is printed; and
separating by the printer the printed multiple promotional coupons from the paper supply.

7. The method of claim 1, further comprising preventing by the printer a pre-calibration of the printer when the printer detects the printer is coupled to the promotional system.

8. The method of claim 1, further comprising:
detecting by a host system the printer during power up of the printer; and
checking by the host system the status of the printer.

9. The method of claim 1, further comprising:
detecting by a host system the printer during power up of the printer; and
notifying the printer of the type of host system.

10. The method of claim 8 and 9, wherein the host system is the promotional system.

12. The method of claim 8 and 9, wherein the host system is the gaming system.

13. The method of claim 1, further comprising generating by the printer a plurality of signatures for a plurality of printer memory sections, the memory sections including firmware, with firmware in at least one memory section for printing gaming vouchers and firmware in at least one other memory section for printing promotional coupons.

14. A printer, comprising:
means for detecting if the printer is coupled to a cashless enabled game within a gaming system;
means for detecting if the printer is coupled to a promotional system;
means for performing gaming voucher printing when the printer detects the printer is coupled to the cashless enabled game;
means for performing promotional coupon printing when the printer detects the printer is coupled to the promotional system; and
means for performing both gaming voucher printing and promotional coupon printing when the printer detects the printer is coupled to both the cashless enabled game and the promotional system.

15. The printer of claim 14, further comprising means for performing detecting if the printer is coupled to the cashless enabled game within a gaming system and detecting if the printer is coupled to the promotional system when power is cycled to the printer.

16. The printer of claim 14, further comprising means for performing detecting if the printer is coupled to the cashless enabled game within a gaming system and performing detecting if the printer is coupled to the promotional system on a periodic basis.

17. The printer of claim 14, further comprising means for performing a pre-calibration when the printer detects the printer is coupled to the cashless enabled game.

18. The printer of claim 14, further comprising means for performing a coupon holding process when the printer detects the printer is coupled to the promotional system, the coupon holding process preventing individual promotional coupons from being separated from a paper supply if multiple promotional coupons are being printed.

19. The printer of claim 18, further comprising:
means for detecting when the last promotional coupon is printed; and
means for separating the printed multiple promotional coupons from the paper supply.

20. The printer of claim 14, further comprising means for preventing a pre-calibration of the printer when the printer detects the printer is coupled to the promotional system.

21. The printer of claim 14, further comprising means for generating by the printer a plurality of signatures for a plurality of printer memory sections, the memory sections including firmware, with firmware in at least one memory section for printing gaming vouchers and firmware in at least one other memory section for printing promotional coupons.
